(19) United States
(12) Patent Application Publication
(10) Pub. No.: US 2020/0184588 A1
(43) Pub. Date: Jun. 11, 2020

(54) METHOD AND SYSTEMS FOR QUANTIFYING ORGANIZATIONAL CULTURE

(71) Applicant: Kadem Education, LLC, Royersford, PA (US)

(72) Inventors: David SHAFER, Royersford, PA (US); Robert NEU, Enumclaw, WA (US); Philip LANOUE, Marietta, SC (US); Douglas BULLARD, New Hope, PA (US)

(21) Appl. No.: 16/710,799

(22) Filed: Dec. 11, 2019

Related U.S. Application Data
(60) Provisional application No. 62/778,164, filed on Dec. 11, 2018.

(51) Int. Cl. G06Q 50/20; G06F 16/9535; G06F 16/9538; G06Q 10/06

(52) U.S. Cl. CPC G06Q 50/205; G06F 16/9535; G06Q 10/06393; G06Q 10/063114; G06F 16/9538

(57) ABSTRACT

The disclosure provides a cultural assessment system for a method of assessing culture of a school. The method may include collecting continuous school culture indicator ratings from teachers of the school via a web application, the continuous school culture indicator ratings being for each individual teacher for each of a plurality of school culture indicators for each of a plurality of school culture drivers. The method may include generating school culture driver scores for each of the plurality of school culture drivers based on the continuous school culture indicator ratings of the teachers of the school. The method may include displaying to the individual teacher, a comparison of school culture driver scores of the school and school culture driver scores of the individual teacher based on the continuous school culture indicator ratings of the individual teacher.

This application claims priority to U.S. Provisional Application Number 62/778,164 titled “MEASURING SCHOOL CULTURE,” filed Dec. 11, 2018, which is assigned to the assignee hereof, and incorporated herein by reference in its entirety.

### BACKGROUND

Organizations such as educational institutions including schools, colleges, and universities employ professionals with a relatively large degree of autonomy. Teacher retention is a major concern for such institutions because demand is relatively inelastic. Professional Learning and onboarding of new teachers is time consuming and expensive. Additionally, student performance is impacted when there is a teacher shortage or high teacher turnover. These effects are especially prevalent in schools in areas with high poverty rates compared to areas with low poverty rates.

In such organizations, organizational generating partitioned organizational culture scores culture plays an important role in job satisfaction, employee performance, and employee retention. While organizational culture is important to organizational success conventional approaches to organizational culture revolve around soft concepts such as feelings, morale, and subjective valuations. Accordingly, little has been done to effectively define, monitor and evaluate culture within organizations.

Thus, there remains an unmet need in educational organizations to define and quantify culture within organizations. Culture is also important for retaining employees in other organizations and fields. Accordingly, other organizations such as non-profit organizations and businesses may also have an unmet need to define and quantify culture within the organization.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect, the disclosure provides a method of assessing the culture of a school. The method may include collecting continuous school culture indicator ratings from teachers of the school via a web application, the continuous school culture indicator ratings being for each individual teacher for each of a plurality of school culture indicators for each of a plurality of school culture drivers. The method may include generating school culture driver scores for each of the plurality of school culture drivers based on the continuous school culture indicator ratings of the teachers of the school.

In an aspect, the method may further include displaying to the individual teacher, a comparison of school culture driver scores of the school and school culture driver scores of the individual teacher based on the continuous school culture indicator ratings of the individual teacher.

In an aspect, the web application includes a user interface that presents to the individual teacher a previous school culture indicator rating for each of the plurality of school culture indicators for one of the plurality of school culture drivers. The user interface allows the individual teacher to change the previous school culture indicator ratings and to update the school culture driver scores of the school and the school culture driver scores of the individual teacher. The method may further include receiving, from the web application for the individual teacher, a change to one or more current school culture indicator ratings of the individual teacher. The method may further include updating the school culture driver scores of the school based on the change to one or more current school culture indicator ratings of the individual teacher and current school culture driver scores of other teachers of the school. The method may further include storing the change to one or more current school culture indicator ratings in association with a time of the change. The method may further include receiving one or more dates of events at the school. The method may further include correlating one or more changes of the school culture driver scores to the events at the school.

In an aspect, the plurality of school culture drivers include: Direction, Profession Engagement, Instructional Autonomy, Collaboration, Empowerment, Feedback and Reflection, Resource Priorities, Support and Care, Sense of Belonging, and Teacher Advancement.

In an aspect, the web application includes a user interface that collects biographical information of the individual teacher. The method may further include generating partitioned school culture driver scores and partitioned school culture indicator ratings of the school based on the biographical information. The partitioned school culture driver scores and partitioned school culture indicator ratings of the school may be partitioned based on one or more of: teacher career length, teacher school service length, teacher-principal relationship length, number of schools for each teacher, or number of principals for each teacher.

In an aspect, the school culture driver scores of the school are quantized levels of agreement among the teachers of the school regarding a level of each school culture driver at the school. The method may further include displaying to a school leader a graphical breakdown of the quantized levels of agreement among the teachers of the school.

In an aspect, the method may further include displaying to a school leader a school initial inventory, the school culture driver scores of the school, and a leader inventory for school culture indicator ratings and driver scores for each of the plurality of school culture drivers.

In an aspect, the method may further include tracking activity of the teachers of the school and displaying a participation rate of the teachers.

In another aspect, the disclosure provides a method of evaluating organizational culture. The method may include collecting continuous organizational culture indicator ratings from individuals within an organization via a web application, the continuous organizational culture indicator ratings being for an individual for each of a plurality of organizational culture indicators for each of a plurality of organizational culture drivers, wherein the web application includes a user interface that presents to the individual a current organizational culture indicator rating for each of the plurality of organizational culture indicators for one of the plurality of organizational culture drivers. The method may include generating organizational culture driver scores for each of the plurality of school culture drivers based on the continuous organizational culture indicator ratings of the individuals within the organization. The method may include displaying a comparison of the organizational culture driver scores and individual organizational culture driver scores based on the continuous organizational culture indicator ratings of the individual.

In another aspect, the disclosure provides a user interface. The user interface may include a plurality of input screens displaying input mechanisms for collecting continuous school culture indicator ratings from a teacher of a school, each input screen recording a current school culture indicator rating for the teacher for each of a plurality of school culture indicators for one of a plurality of school culture drivers. The user interface may include a result interface displaying a comparison of school culture driver scores based on current school culture indicator ratings from a plurality of teachers of the school with an individual school culture driver score based on the continuous ratings of the school culture indicators of the teacher.

In an aspect, the user interface may include a biographical data input screen including input mechanisms for collecting biographical information of the teacher.

In an aspect, the user interface may include a leader result interface displaying school culture indicator ratings and school culture driver scores partitioned based on biographical information of teachers of the school. The leader result interface may display changes in the school culture indicator ratings and driver scores over time.

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a diagram illustrating an example computer network for connecting multiple users to a professional development system.

FIG. 2 is a diagram illustrating an example computer system.

FIG. 3 is a diagram illustrating an example user interface for a user dashboard.

FIG. 4 is a diagram illustrating an example user interface for continuous assessment of a driver.

FIG. 5 is a diagram illustrating an example user interface for organizational results.

FIG. 6 is a diagram illustrating an example user interface for collecting biographical information.

FIG. 7 is a diagram illustrating an example user interface for a leader dashboard.

FIG. 8 illustrates an example user interface for displaying continuous assessment results to a leader.

FIG. 9 illustrates an example user interface for monitoring participation and tracking score changes.

FIG. 10 is a diagram illustrating an example user interface for collecting leader biographical information.

FIG. 11 is illustrates a flowchart showing an example method for quantizing culture at an organization.

FIG. 12 illustrates a flowchart showing an example method of quantizing culture at a school.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

The disclosure provides a system and methods for measuring a culture of an organization such as a school. The system may include a web application that provides a client to a user device of each member (e.g., each teacher) of the organization (e.g., school). The web application may collect continuous school culture indicator ratings from the members (e.g., teachers) of the organization (e.g., school). In particular, the continuous school culture assessment may record a current school culture indicator rating for each individual teacher for each of a plurality of school culture indicators for each of a plurality of school culture drivers. The continuous culture assessment may allow the teachers to update their school culture indicator ratings at any time. The system may generate school culture driver scores for each of the plurality of school culture drivers for both individual teachers and for the school based on the continuous rating of the school culture indicators of the teachers of the school. The system may display the school culture indicator ratings and the school culture driver scores to the teachers and/or leaders of the school. The system may provide a comparison between a school culture driver score based on a continuous ratings of school culture indicators for an individual teacher and school culture driver scores of the school. Similarly, the system may provide a comparison between a leader inventory of school culture indicator ratings and driver scores and the school culture indicator ratings and school culture driver scores of the school.

In an aspect, the system includes unique interfaces for facilitating the collection of information and displaying the school culture indicator ratings and driver scores. Additionally, the system includes interfaces for collecting biographical information, displaying partitioned school culture indicator ratings and driver scores and breakdowns of these ratings and scores, and tracking teacher engagement with the system. Additionally, the system may be adapted to assess the culture of any organization.

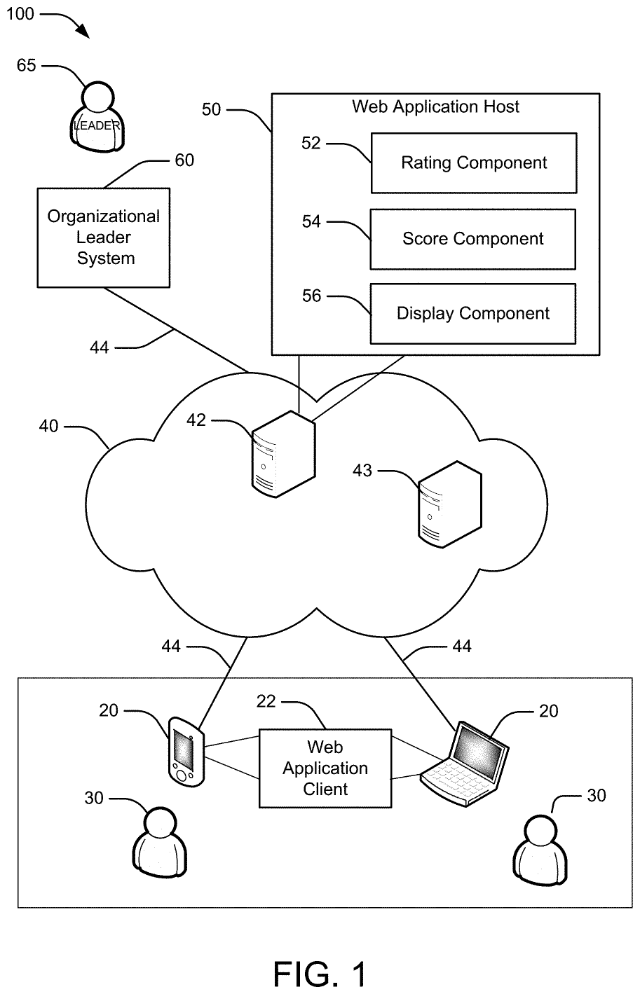

FIG. 1 illustrates an example cultural assessment system 100 for quantifying culture within an organization. The system 100 may be an example educational solution for assessing and continually monitoring the culture within a school. Similar systems may be implemented for other institutions and organizations. The system 100 may support organizational leaders to evaluate culture within the organization and establish cooperative and collective decision making processes to improve the culture within the organization. As used herein, culture refers to the relationship between the leadership of an organization and individuals within the organization. The system 100 may provide individuals (e.g., teachers) within the organization (e.g., school) with the ability to provide a continuous assessment of the culture within the organization. The system 100 may provide a continuously updated quantitative score that provides both individuals and leaders with insight into culture within the organization as well as differing view of various groups of individuals.

The system 100 may include one or more servers such as an application server 42 and a storage server 43, which may be implemented in a network 40 (e.g., in the cloud). The system 100 may include one or more user devices 20 that interact with the network 40 to provide an interface for a user 30 to interact with the system 100. The application server 42 may host a web application 50 that facilitates communications between the users 30 and the system 100. Each user device 20 may include a web application client 22 that presents an individualized web application to the user 30. For instance, the web application client 22 may be a web browser executing a web page for the web application or a mobile application. The user 30 may log into the web application with a username and password. The usernames for an organization may be generated when an organization enrolls with the system 100, and new usernames may be created when individuals join the organization. The web application 50 may include a rating component 52 that generates user interfaces to present a continuous rating to a user 30 via a user device 20. The web application 50 may include a score component 54 that generates at least an individual cultural score and an organizational cultural score. The web application 50 may include a display component 56 that generates one or more graphical representations of the cultural scores and/or underlying data.

The user device 20 may be communicatively coupled with the network 40. The network 40 may include any network that allows communication between the various entities of the system 100. In an aspect, the network 40 may be a communications network and may include or be connected with other networks. For example, the user device 20 may include a modem and be coupled with the network 40 via a wired or wireless connection. The network 40 may include one or more computer servers such as application server 42 and storage server 43. The application servers 42 may include information for managing the system 100 including software for providing an interactive online application for the users 30. In an aspect, for example, application servers 42 may interact with user devices 20 for providing various interfaces or notification servers for providing messages to the users 30. The term “user” may refer to any person accessing the system 100. A user may be associated with a role that controls access to one or more features or one or more views of the one or more features. Example roles for an organization include: individual, organizational leader, and administrator. For example, in a school organization, the individuals may be teachers, teacher assistants, or specialty teachers. The leader in a school organization may be building or district leaders such as section leaders (e.g., head of mathematics,) vice principals, principals, superintendents, school board members, or school board officers. In a non-profit organization, the individuals may be volunteers or employees, and the leaders may be directors or managers. In an aspect, the system 100 may include separate systems (e.g., organizational leader system 60) for users with a specific role (e.g., leader 65). In an aspect, a user may have more than one role. For example, a user may be both an organizational leader and a teacher.

The application servers 42 may execute a web application 50 that may allow users 30 and leaders 65, or administrators to interact with the system 100 in the defined roles. For example, the organizational leader system 60 may provide an application for leaders 65 to interact with the system 100 for communicating with users 30. The network 40 may also include storage servers 43 for storing user information, content, billing information, etc.

In one aspect of the disclosure, various data is, for example, input and/or accessed by the users 30, leaders 65, or other users via user devices 20 such as personal computers (PCs), minicomputers, mainframe computers, microcomputers, telephonic devices, wireless devices, personal digital assistants (“PDAs”), or mobile devices (e.g., smart phones). The user devices 20 may be coupled with the application server 42, which may be implemented as a PC, minicomputer, mainframe computer, microcomputer, or other device having a processor and a repository for data and/or connection to a repository for data, via, for example, the network 40, such as the Internet or an intranet, and/or a wireless network. The couplings 44 include, for example, wired and/or wireless connections.

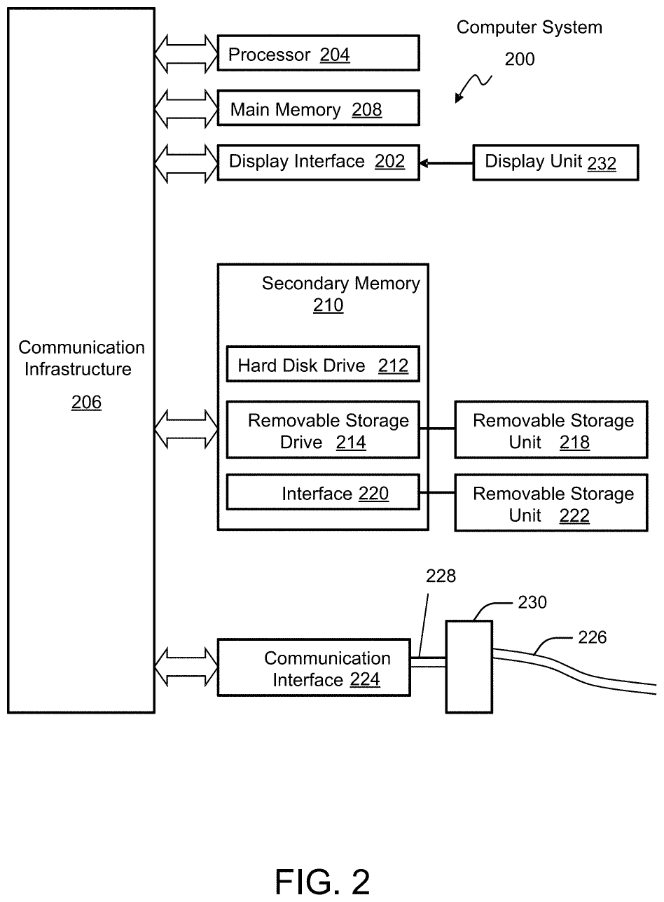

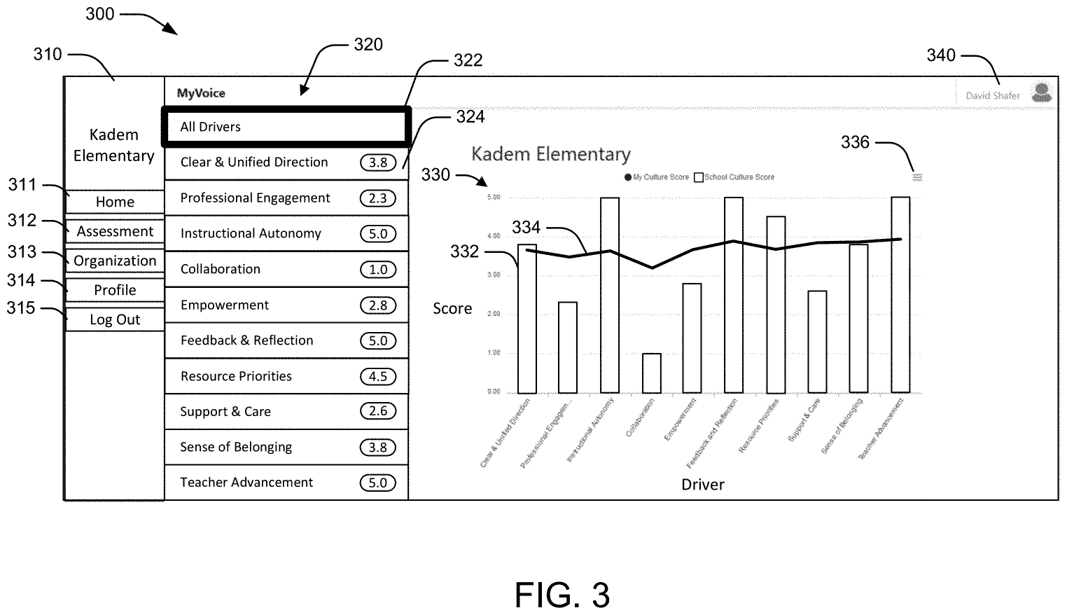

Aspects of the present disclosure may be implemented using hardware, software executed by a processor, or a combination thereof and may be implemented in one or more computer systems or other processing systems. For example, the user interfaces illustrated in FIGS. 3-10 may be implemented as a computer system or processing system. Also, the organizational leader system 60 may be implemented as a computer system or processing system. In an aspect of the present disclosure, features are directed toward one or more computer systems capable of carrying out the functionality described herein. An example of such a computer system 200 is shown in FIG. 2.

Computer system 200 includes one or more processors, such as processor 204. The processor 204 may be coupled with a communication infrastructure 206 (e.g., a communications bus, cross-over bar, or network). Various software aspects are described in terms of this example computer system. After reading this description, it will become apparent to a person skilled in the relevant art(s) how to implement aspects hereof using other computer systems and/or architectures.

Computer system 200 may include a display interface 202 that forwards graphics, text, and other data from the communication infrastructure 206 (or from a frame buffer not shown) for display on a display unit 232. For example, the display unit 232 may display the user interfaces described herein. Computer system 200 may include a main memory 208, preferably random access memory (RAM), and may also include a secondary memory 210. The secondary memory 210 may include, for example, a hard disk drive 212 and/or a removable storage drive 214, e.g., an optical disk drive. The removable storage drive 214 may read from and/or write to a removable storage unit 218 in a well-known manner. As will be appreciated, the removable storage unit 218 may include a computer readable storage medium having stored therein computer software and/or data.

Alternative aspects of the present invention may include secondary memory 210 and may include other similar devices for allowing computer programs or other instructions to be loaded into computer system 200. Such devices may include, for example, a removable storage unit 222 and an interface 220. Examples of such may include a removable memory chip (such as an erasable programmable read only memory (EPROM), or programmable read only memory (PROM)) and associated socket, and other removable storage units 222 and interfaces 220, which allow software and data to be transferred from the removable storage unit 222 to computer system 200.

Computer system 200 may also include a communications interface 224. Communications interface 224 may allow software and data to be transferred among the computer system 200 and external devices. Examples of communications interface 224 may include a modem, a network interface (such as an Ethernet card), a communications port, a Personal Computer Memory Card International Association (PCMCIA) slot and card, etc. Software and data transferred via communications interface 224 may be in the form of signals 228, which may be electronic, electromagnetic, optical or other signals capable of being received by communications interface 224. These signals 228 may be provided to communications interface 224 via a communications path (e.g., channel) 226. This communications path 226 may carry signals 228 and may be implemented using wire or cable, fiber optics, a telephone line, a cellular link, a radio frequency (RF) link and/or other communications channels. The communications path 226 may include a router 230. As used herein, the terms “computer readable medium,” “computer program medium,” and “computer usable medium” refer generally to media such as a removable storage drive 280, and/or a hard disk installed in hard disk drive 270. Such media may be non-transitory computer-readable media. These computer program products may provide software to the computer system 200. Aspects of the present invention are directed to such computer program products.

Computer programs (also referred to as computer control logic) may be stored in main memory 208 and/or secondary memory 210. Computer programs may also be received via communications interface 224. Such computer programs, when executed, may enable the computer system 200 to perform the features in accordance with aspects of the present invention, as discussed herein. In particular, the computer programs, when executed, may enable the processor 204 to perform the features in accordance with aspects of the present invention. Accordingly, such computer programs may represent controllers of the computer system 200.

Where aspects of the present invention may be implemented using software, the software may be stored in a computer program product and loaded into computer system 200 using removable storage drive 214, hard disk drive 212, or interface 220. The control logic (software), when executed by the processor 204, may cause the processor 204 to perform the functions described herein. In another aspect of the present disclosure, the system may be implemented primarily in hardware using, for example, hardware components, such as application specific integrated circuits (ASICs). Implementation of the hardware state machine so as to perform the functions described herein will be apparent to persons skilled in the relevant art(s). In yet another variation, aspects of the present disclosure may be implemented using a combination of both hardware and software.

FIG. 3 is a diagram illustrating an example user interface 300 for a user dashboard that provides a user 30 with an overview of an organizational culture score and an individual culture score. For example, the organization may be a school (e.g., Kadem Elementary) and the individual may be a teacher. The user interface 300 may include a menu 310, a driver selection menu 320, a chart 330, and a user menu 340.

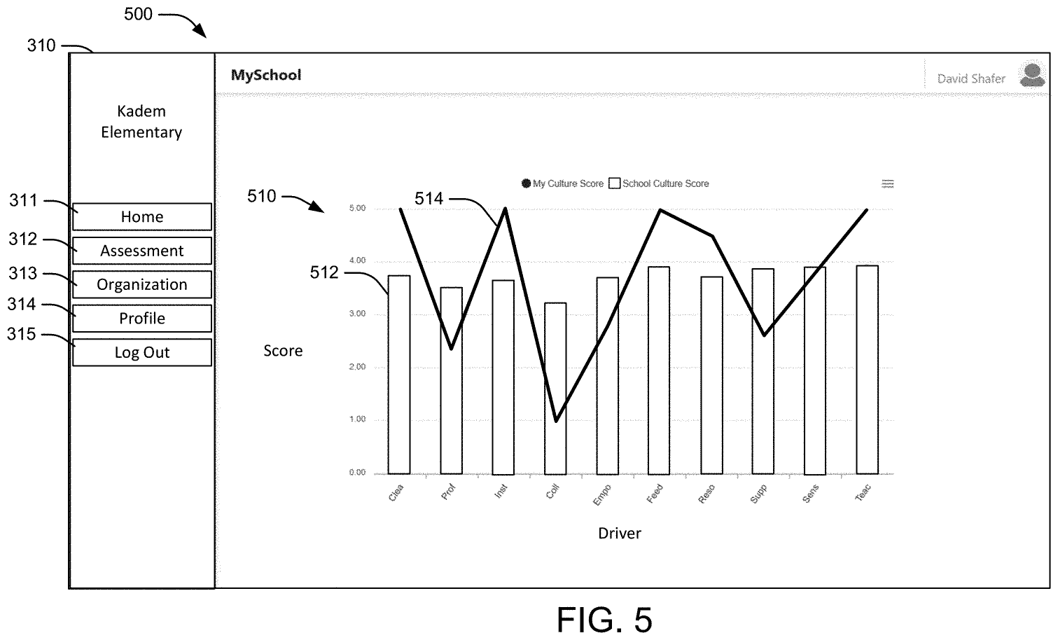

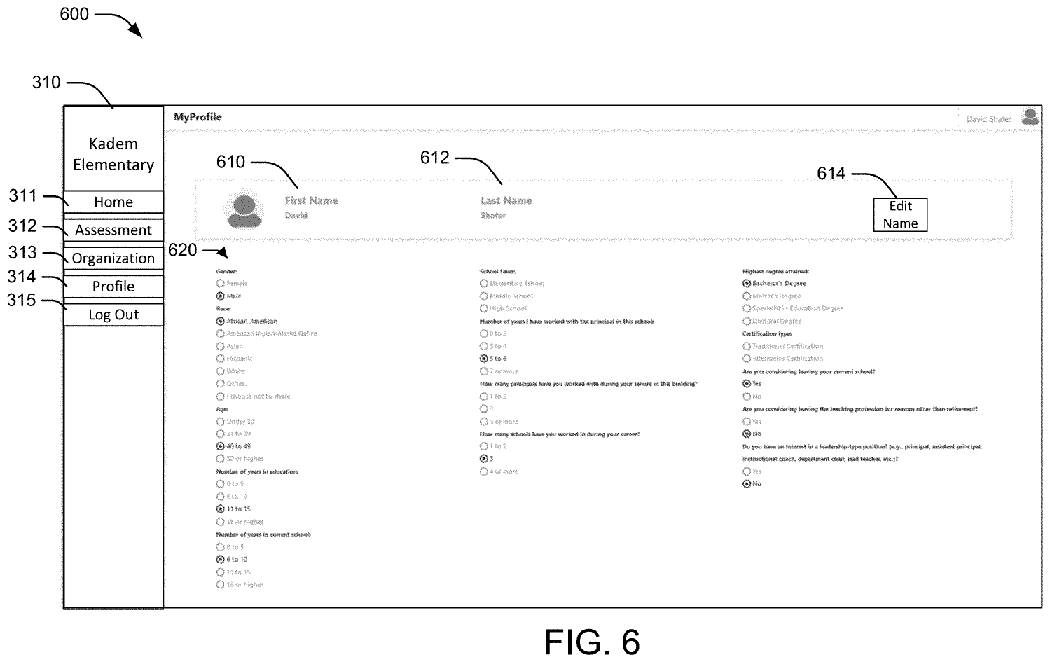

The menu 310 may include navigation options for accessing various features of the system 100. For example, the menu 310 may include a home button 311, an assessment button 312, an organization button 313, a profile button 314, and a log out button 315. The home button 311 may provide an interface that presents basic information such as an explanation of the system 100. The assessment button 312 may provide the user interface 300 when selected from another interface. The organization button 313 may provide an organization user interface 500, which is described in detail below with respect to FIG. 5. The profile button 314 may provide a biographical user interface 600, which is described in detail below with respect to FIG. 6. The log out button 315 may disable a connection between the user 30 and the system 100. The user menu 340 may display a name of the user and include the same functionality as the profile button 314.

The driver selection menu 320 may provide options for the user 30 to select an overview 322 of all school culture drivers (of which scores were calculated from school culture indicators), or select an individual driver button 324. As illustrated, selection of the overview 322 provides the chart 330, which shows both individual and organizational school culture driver scores. In the illustrated example for a school, the organizational culture driver scores are school culture driver scores. The scores may be shown using different representations. For example, the individual school culture driver scores for each school culture driver may be shown as bars 332 and the organizational culture scores for each school culture driver may be shown as a line 334. Other display options may include multiple bars or lines. In an aspect, the user 30 may select options for displaying the individual school culture driver scores and organizational school culture driver scores. A download button 336 may allow the data for the chart 330 to be saved locally in various formats.

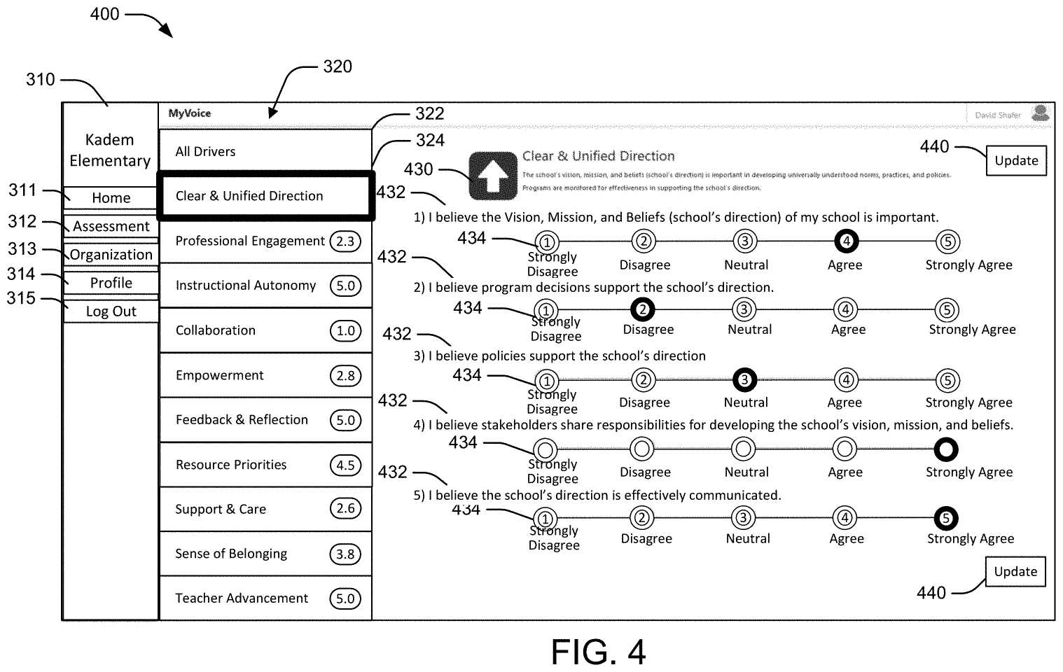

The individual school culture driver buttons 324 may each provide a user interface such as the example interface 400 illustrated in FIG. 4. The school culture drivers may be characteristics of the organization that drive individual satisfaction with the organization and retention of individuals within the organization. The school culture drivers for an organization may be research backed cultural drivers that have been shown to correspond to satisfaction and retention. For example, for an educational organization such as a school, the drivers may include: Clear & Unified Direction, Professional Engagement, Instructional Autonomy, Collaboration, Empowerment, Feedback and Reflection, Resource Priorities, Support & Care, Sense of Belonging, and Teacher Advancement. These drivers may be adapted to other types of organizations. For other organizations, the cultural drivers may include: Clear & Unified Direction, Professional Engagement, Individual Autonomy, Collaboration, Empowerment, Feedback and Reflection, Resource Priorities, Support & Care, Sense of Belonging, and Individual Advancement.

Turning to FIG. 4, the user interface 400 provides an assessment tool for an individual driver. The user interface 400 may include elements of the user interface 300 such as the menu 310 and the school culture driver selection menu 320. In this example, the Clear & Unified Direction button 324 is selected and displayed. The user interface 400 may provide an input mechanism for a continuous school culture indicator rating. The user interface 400 may display a school culture driver description 430 for the selected school culture driver. The school culture driver description 430 may include an icon representing the school culture driver. The user interface 400 may include a plurality of statements 432 that relate to the school culture driver description 430. For each statement 432, the user interface 400 may include an input mechanism 434 that allows the user 30 to select a level of agreement. For example, the input mechanisms 434 are illustrated as selectable points on a scale and selected values are bolded. Other input mechanisms such as menus, fields, sliding bars, radio buttons, or pick lists may be used instead. In an aspect, the input mechanism 434 allows selection of the level of agreement from a five point scale with numerical values 1-5 and textual descriptions of “Strongly Disagree,” “Disagree,” “Neutral,” “Agree,” and “Strongly Disagree.” The first time the user 30 accesses the user interface 400, the input mechanisms 434 may show no selected value. The user 30 may select a different value for each statement 432. When the user 30 accesses the user interface 400 to updates selected values, the user interface 400 may present the previously selected values. The user 30 may change the selected value and select the update button 440 to save the updated response values to the web application 50.

Example statements for the Clear & Unified Direction school culture driver are illustrated in FIG. 4 and include: “I believe the Vision, Mission, and Beliefs (school's direction) of my school is important,” “I believe program decisions support the school's direction,” “I believe policies support the school's direction,” “I believe stakeholders share responsibilities for developing the school's vision, mission, and beliefs,” and “I believe the school's direction is effectively communicated.”

Example statements for the Professional Engagement school culture driver may include: “I believe professional growth is an expectation to meet student, teacher, and system needs,” “I believe professional learning is offered through a variety of modalities (individual, group, online, etc.),” “I believe professional learning initiatives improves instructional practices,” “I believe leaders learn with teachers,” “I believe conversations on instructional practices occur regularly,” and “I believe follow-up support is offered after professional learning has occurred.”

Example statements for the Instructional Autonomy school culture driver may include: “I believe the curriculum allows for flexibility at the school level,” “I believe teachers have the autonomy to make classroom instructional decisions,” “I believe teachers are encouraged, supported, and feel safe in trying new instructional designs,” “I believe high-stakes testing is viewed as only one part of a comprehensive assessment system,” and “I believe effective instructional models are shared.”

Example statements for the Collaboration school culture driver may include: “I believe time is regularly allocated for collaborative planning across grades and/or disciplines,” “I believe teachers collaboratively plan instructional lessons and select resources,” “I believe teachers collectively assess the effectiveness of instructional practices,” and “I believe professional learning is a part of the collaborative planning process.”

Example statements for the Empowerment school culture driver may include: “I believe teachers have the freedom to make classroom-level decisions to meet the needs of students,” “I believe teachers are involved in developing school rules and policies,” “believe teachers are involved in school improvement processes,” “I believe teacher engagement in school-wide decisions is valued,” and “I believe teacher voice is important in the development of professional learning opportunities.”

Example statements for the Feedback and Reflection school culture driver may include: “I believe classroom observations and walkthroughs frame specific feedback,” “I believe feedback on instructional practice is immediate,” “I believe artifacts and evidence from practice are used to engage teachers in conversations about their practices,” and “I believe reflection is modeled and encouraged to help teachers learn from their own and the practices of others.”

Example statements for the Resource Priorities school culture driver may include: “I believe teacher schedules are based upon their strengths,” “I believe teacher schedules are based upon students' needs,” “I believe teachers are involved in the selection of instructional resources,” and “I believe resources are allocated for teachers to innovate.”

Example statements for the Support & Care school culture driver may include: “I believe teacher mentoring is embedded through interactions with experienced colleagues,” “I believe processes are in place to provide new teachers with timely support,” “I believe teachers observe and give feedback to each other through peer observations,” “I believe teachers have created support structures to seek advice and discuss concerns around classroom practices,” and “I believe teachers care about each other.”

Example statements for the Sense of Belonging school culture driver may include: “I believe teachers feel their safety and well-being are valued,” “I believe teachers feel valued for the diversity they bring to the school,” “I believe teachers feel like they are a part of the school,” “I believe teachers feel like they belong in the school,” and “I believe school programs create a sense of belonging.”

Example statements for the Teacher Advancement school culture driver may include: “I believe teacher interests are used to expand opportunities for career growth,” “I believe opportunities are created for teachers to be leaders,” “I believe professional learning supports career advancement opportunities,” “I believe teachers are supported in becoming experts in their field(s),” and “I believe teachers feel valued for their expertise.”

The user interface 400 may include an update button 440 that saves the current selections on the user interface 400 as the user's new selected values. In an aspect, a user 30 may access the user interface 400 and update the values for the statements 432 at any time. When the user selects the update button 440, the system 100 may update both the individual scores and the organizational scores based on the new selected values. The new selected values may be combined with previously selected values of other users when the system 100 generates the organizational scores. Accordingly, the system 100 may provide a continuous assessment that may change as individuals update the individual values via the user interface 400. The continuous assessment allows individuals to update school culture indicator ratings at any time and provides updated school culture driver scores in real-time as the individuals update the school culture indicator ratings.

FIG. 5 is a diagram illustrating an example user interface 500 for organizational results. The user interface 500 may include some elements of the user interface 300 such as the menu 310. The user interface 500 may provide a chart 510 showing the individual school culture scores and the organizational school culture scores for each driver. For example, the chart 510 may represent the individual school culture score as a line 514 and may represent the organizational school culture scores as bars 512. The system 100 may generate the individual school culture score for each driver based on the current responses for the user 30 for the driver. For example, the individual's school culture score for each school culture driver may be an average of the values of the current school culture indicator ratings for the corresponding school culture driver. The organizational culture driver scores may be based on the individual school culture driver scores for all of the members of the organization who have completed the school culture indicator ratings. For example, the organizational score for a school culture driver may be an average of the individual school culture driver scores for each individual within the organization that has rated the school culture indicators. In an aspect, the average may be affected by how recently the individual updated the school culture indicator ratings For example, only school culture indicator ratings updated within a recent time period (e.g., month or school year) may be considered, or a weight may be applied to the individual school culture indicator ratings, for example, using a decay function to provide greater weight to more recent school culture indicator ratings.

FIG. 6 is a diagram illustrating an example user interface 600 for collecting biographical information. The user interface 600 may include some elements of the user interface 300 such as the menu 310. The user interface 600 may be accessed by selecting the profile button 314. The user interface 600 may include a name field including a first name 610 and a last name 612. The user 30 may edit either the first name 610 or the last name 612 by selecting the edit name button 614 and typing an updated name (e.g., in the case of a name change). The user interface 600 may include biographical characteristic selections 620. Each biographical characteristic selection 620 may provide an input mechanism for selecting an option. Example biographical characteristic selections for an educational organization (e.g., a school) include: gender, race, age, number of years in education, number of years in current school, school level, number of years worked with the principal in this school, how many principals the individual has worked with in the school, how many schools the individual has worked in during a career, a highest degree attained, a certification type, whether the individual is considering leaving the school, whether the individual is considering leaving the teaching profession, and interest in leadership positions. The user 30 may optionally provide biographical information by selecting the appropriate answer using the input mechanism for each biographical characteristic selection 620. In an aspect, the system 100 may use the biographical information to generate partitioned organization cultural driver scores and organization school culture indicator ratings. The partitioned school culture indicator ratings and driver scores may be partitioned according to one or more biographical characteristic selections 620. For example, the system 100 may generate organizational cultural scores partitioned by teacher experience, which may be useful to determine whether perception of organizational culture varies based on teacher experience. As another example, the partitioned school culture indicator ratings and driver scores may illustrate differences in perception of organizational culture by gender or age.

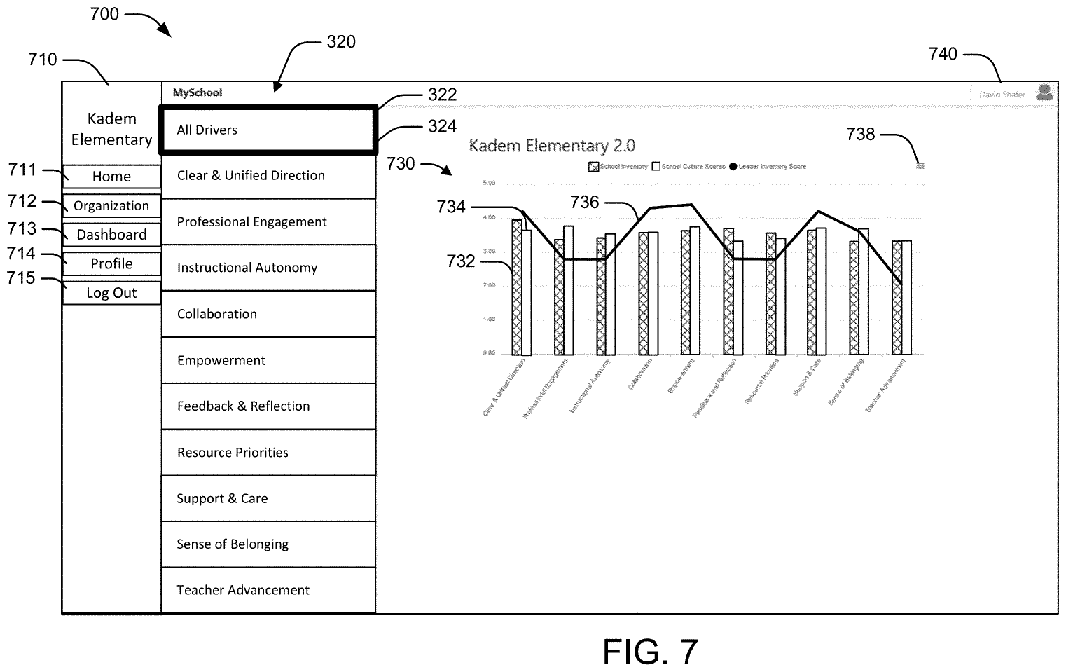

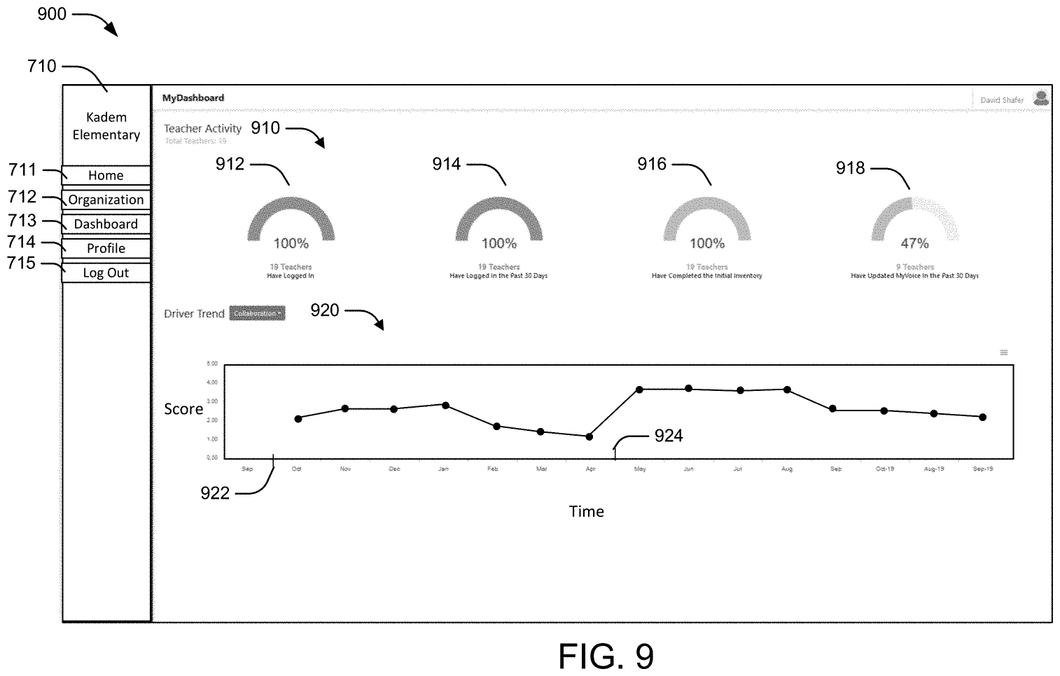

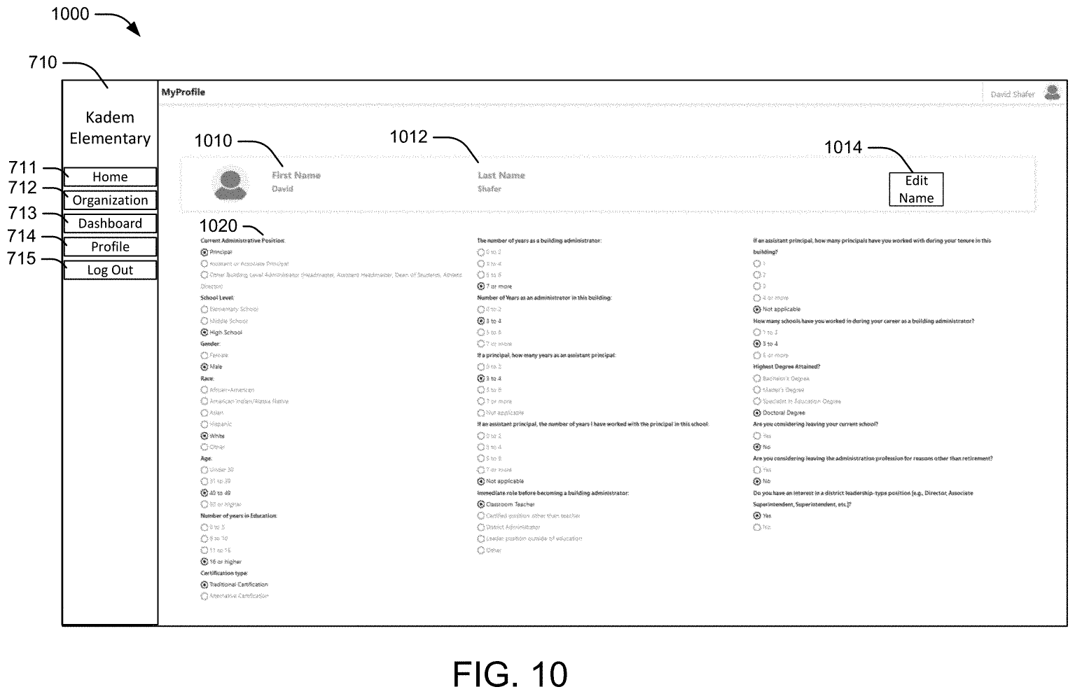

FIG. 7 is a diagram illustrating an example user interface 700 for a leader dashboard that provides an overview of organizational school culture driver scores to a leader 65. The leader 65 may log into the system 100. The system 100 may provide the user interface 700 to the leader 65 based on the role of the leader 65. The user interface 700 may include elements similar to the user interface 300 such as a menu 710 and the driver selection menu 720. The menu 710 may include navigation options for accessing various features of the system 100. For example, the menu 710 may include a home button 711, an organization button 712, a dashboard button 713, a profile button 714, and a log out button 715. The home button 711 may provide an interface that presents basic information such as an explanation of the system 100. The organization button 712 may provide the user interface 700 when selected from another interface. The dashboard button 713 may provide a participation dashboard user interface 900, which is described in detail below with respect to FIG. 9. The profile button 714 may provide a biographical user interface 1000, which is described in detail below with respect to FIG. 10. The log out button 715 may disable a connection between the leader 65 and the system 100. The user menu 740 may display a name of the leader 65 and include the same functionality as the profile button 714.

The school culture driver selection menu 720 may be similar to the school culture driver selection menu 320 and include an all school culture drivers button 722 and individual school culture driver buttons 724. The all school culture drivers button 722 may be selected to display the user interface 700. The user interface 700 may include a chart 730 that shows an organization school culture inventory, an organizational culture score, and a leader inventory school driver score. For example, the organization inventory may be represented by first bars 732, the organizational culture score may be represented by second bars 734, and the leader school culture inventory score may be represented by line 736. Similar to the interfaces 300 and 500, the leader 65 may select a representation for the organization school culture inventory, leader school culture inventory driver score, and organizational culture driver score. The organizational culture score for each driver may be the same score as discussed above for individuals or users 30. The leader inventory driver score may be similar to the individual driver score discussed above, but based on ratings provided by the leader 65 instead of an individual. The organization inventory of its leaders may be an average of leader inventory driver scores for multiple leaders within the organization. By representing the organization inventory, the organizational cultural driver score, and the leader inventory on the same chart 730, the user interface 700 may provide the leader 65 with a graphical representation of how the leader's ratings differ from the individuals within the organization and other leaders. The user interface 700 may include a download button 738 for the leader 65 to download the chart 730 or underlying data in various formats.

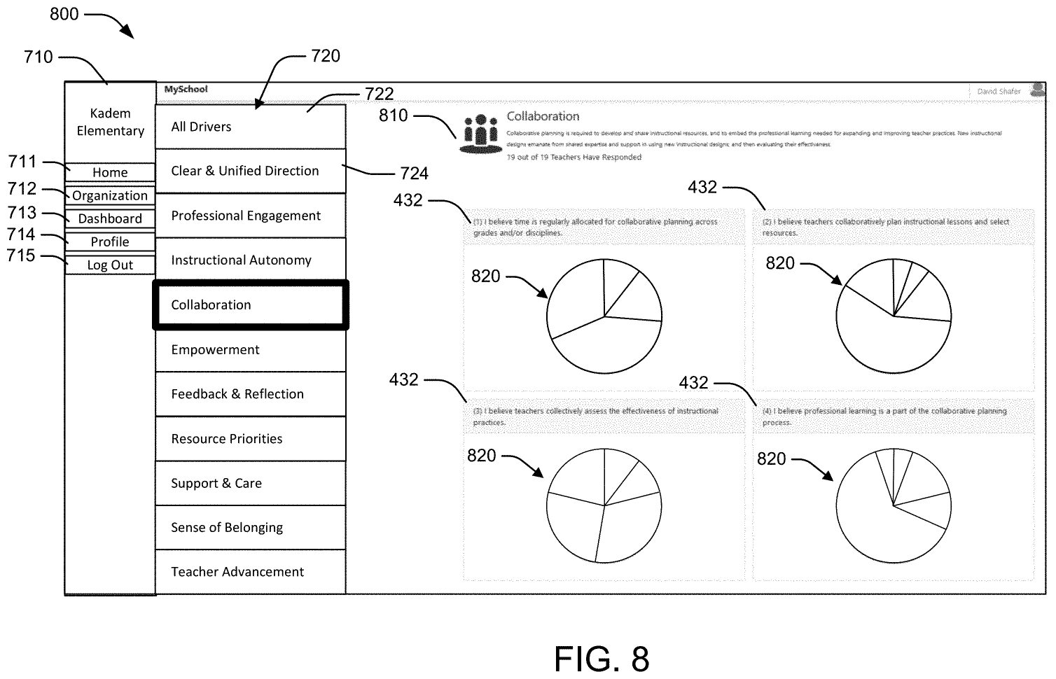

FIG. 8 illustrates an example user interface 800 for displaying continuous ratings for a driver to a leader. The user interface 800 may include elements of the user interface 700 such as the menu 710 and the school culture driver selection menu 720. The user interface 800 may provide a detailed explanation of the organizational culture score for a driver to the leader 65. The user interface 800 may be accessed by the leader 65 selecting one of the individual school culture driver buttons 724. The user interface 800 may include a school culture driver description 810, which may correspond to the school culture driver description 430 and provide an explanation of the school culture driver to the leader 65. The user interface 800 may include the plurality of school culture indicator statements 432 associated with each driver. For each school culture indicator statement 432, the user interface 800 may include a chart 820 showing a breakdown of the current school culture indicator ratings from the individuals within the organization. For example, as illustrated, the chart 820 may be a pie chart showing the percentage of level of agreement with the school culture indicator statement. The charts 820 may provide greater detail than a single numerical school culture driver score and may also indicate a level of agreement among individuals at the organization.

FIG. 9 illustrates an example user interface 900 for monitoring participation and tracking school culture driver score changes. The user interface 900 may be accessed by the leader 65 selecting the dashboard button 713. The user interface 900 may include the menu 710. The user interface 900 may include an activity summary 910 including one or more graphical representations of activity of individuals with the system 100. For example, the user interface 900 may include a graphic 912 showing a number of individuals that have logged in, a graphic 914 showing a number of individuals that have logged in within a time period (e.g., 30 days), a graphic 916 showing a number of individuals that have completed the assessment at least once, and a graphic 918 showing a number of individuals that have updated the assessment within a time period (e.g., 30 days). In an aspect, selecting a graphic 912, 914, 916, 918 may provide further information (e.g., individual names) or allow actions such as sending reminders to encourage participation. For example, selecting a solid section of one of the graphics 912, 914, 916, 918 may provide a list of names of individuals who have responded, and selecting an empty section of one of the graphics 912, 914, 916, 918 may provide a list of names of individuals who have not responded.

The user interface 900 may include a chart 920 showing driver trends. The chart 920 may show an organizational school culture driver score for the driver over time. In an aspect, a leader 65 may indicate dates for events at the organization, and the events may be displayed on the chart 920. For example, an event 922 may indicate initial deployment of the system 100. An event 924 may indicate a date that a change in policy was announced. Accordingly, the chart 920 may show changes in organizational cultural driver scores relative to events. The leader 65 may determine whether the events affected the organizational school culture driver scores.

FIG. 10 is a diagram illustrating an example user interface 1000 for collecting leader biographical information. The user interface 1000 may include some elements of the user interface 700 such as the menu 710. The user interface 1000 may be accessed by selecting the profile button 714. The user interface 1000 may include a name field including a first name 1010 and a last name 1012. The leader 65 may edit either the first name 1010 or the last name 1012 by selecting the edit name button 1014. The user interface 1000 may include biographical characteristic selections 1020. Each biographical characteristic selection 1020 may provide an input mechanism for selecting an option. Example biographical characteristic selections for a leader at an educational organization (e.g., a school) include: current position, school level, gender, race, age, number of years in education, certification type, number of years as leader, number of years as leader in current building, number of years in previous leader position, previous non-leader position, how many principals the individual has worked with in the school, how many schools the individual has worked as a leader, a highest degree attained, whether the individual is considering leaving the school, whether the individual is considering leaving the educational profession, and interest in higher level leadership positions. The leader 65 may optionally provide biographical information by selecting the appropriate answer using the input mechanism for each biographical characteristic selection 1020.

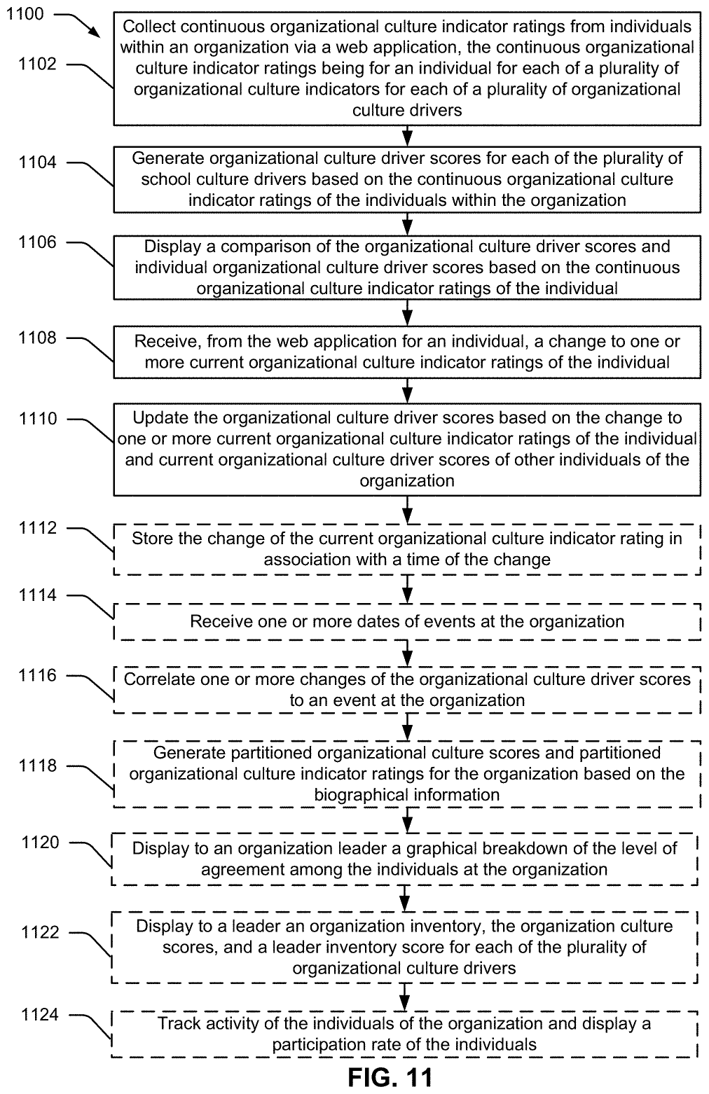

FIG. 11 is illustrates a flowchart showing an example method for quantizing culture at an organization. In an operational aspect, a computer system 200 (FIG. 2) such as the user device 20 (FIG. 1) or a server 42 (FIG. 1) may perform one aspect of a method 1100 for evaluating organizational culture. While, for purposes of simplicity of explanation, the method 1100 is shown and described as a series of acts, it is to be understood and appreciated that the method 1100 (and further methods related thereto) is/are not limited by the order of acts, as some acts may, in accordance with one or more aspects, occur in different orders and/or concurrently with other acts from that shown and described herein. For example, it is to be appreciated that a method could alternatively be represented as a series of interrelated states or events, such as in a state diagram. Moreover, not all illustrated acts may be required to implement a method in accordance with one or more features described herein. Optional blocks are shown in dashed lines.

At block 1102, the method 1100 may include collecting continuous organizational culture indicator ratings from individuals within an organization via a web application, the continuous organizational culture indicator ratings being for an individual for each of a plurality of organizational culture indicators for each of a plurality of organizational culture drivers. In an aspect, for example, the server 42 may execute the web application 50 and/or the rating component 52 to collect continuous school culture indicator ratings from individuals within an organization via the web application 50. The web application 50 may be hosted by the server 42 and include the user interface 400, which may be implemented by the rating component 52. The web application 50 may collect the continuous school culture indicator ratings when the user 30 selects the update button 440. The continuous school culture indicator ratings may record a current response for an individual for each of a plurality of school culture indicators (e.g., statements 432) for each of a plurality of school culture drivers.

At block 1104, the method 1100 may include generating organizational culture driver scores for each of the plurality of school culture drivers based on the continuous organizational culture indicator ratings of the individuals within the organization. In an aspect, for example, the server 42 may execute the web application 50 and/or the score component 54 to generate the organizational culture driver scores for each of the plurality of school culture drivers based on the continuous school culture indicator ratings of the individuals within the organization. For instance, the score component 54 may determine an individual organizational culture driver score for each of the plurality of organizational culture drivers for each individual by averaging the responses for each of the plurality of organizational culture indicators for the school culture driver. The score component 54 may determine the organizational culture driver score for each organizational culture driver by averaging the individual scores for each organizational culture driver of individuals within the organization.

At block 1106, the method 1100 may include displaying a comparison of the organizational culture driver scores and individual organizational culture driver scores based on the continuous organizational culture indicator ratings of the individual. In an aspect, for example, the server 42 may execute the web application 50 and/or the display component 56 to cause the user device 20 to display a comparison (e.g., chart 510) of the organizational culture driver scores (e.g., bars 512) and individual school culture driver scores (e.g., line 514) based on the continuous school culture indicator ratings of the individual.

At block 1108, the method 1100 may include receiving, the web application for an individual, a change to one or more current organizational culture indicator ratings of the individual. In an aspect, for example, the server 42 may execute the web application 50 and/or the rating component 52 to receive, from the web application client 22 for the individual via the user device 20, a change to one or more current organizational culture indicator ratings of the individual. For instance, the user 30 may change the one or more organizational culture indicator ratings using the user interface 400. When the user 30 selects the update button 440, the web application client 22 may provide the new organizational culture indicator ratings to the web application 50 executed on server 42.

At block 1110, the method 1100 may include updating he organizational culture driver scores based on the change to one or more current organizational culture indicator ratings of the individual and current organizational culture driver scores of other individuals of the organization. In an aspect, for example, the server 42 may execute the web application 50 and/or the score component 54 to update the organizational culture driver scores based on the change to one or more current organizational culture indicator ratings of the individual and current organizational culture driver scores of other individuals of the organization. For instance, the score component 54 may determine the average individual and organizational culture driver scores as described above with respect to block 1104 using the new school culture indicator ratings.

At block 1112, the method 1100 may optionally include storing change of the current organizational culture indicator rating in association with a time of the change. In an aspect, for example, the server 42 and/or the storage server 43 may store the change of the current organizational culture indicator ratings in association with a time of the change. The stored change may indicate a time that the organizational culture indicator rating was changed. The stored change may be used to determine activity of individuals within a time period (e.g., for determining graphic 918) or for correlating changes with events.

At block 1114, the method 1100 may optionally include receiving one or more dates of events at the organization. In an aspect, for example, the server 42 may receive one or more dates of events at the organization via the user device 20. For instance, the user interface 900 may allow a leader 65 to input a date of an event by selecting a point on the chart 920 and entering event information into a pop-up window.

At block 1116, the method 1100 may optionally include correlating one or more changes of the organizational culture driver score to an event at the organization. In an aspect, for example, the server 42 may correlate one or more changes of the organizational culture driver score to an event at the organization. For instance, the server 42 may determine a magnitude and a direction of the change during a period following an event. The period may be, for example, 1 week.

At block 1118, the method 1100 may optionally include generating partitioned organizational culture scores and partitioned organizational culture indicator ratings for the organization based on the biographical information. In an aspect, for example, the server 42 may generate partitioned organizational culture scores and partitioned organizational culture indicator ratings for the organization based on the biographical information. The partitioned organizational culture driver scores may be an organizational culture driver score for a subset of the individuals at the organization that match a selected biographical characteristic. For instance, the server 42 may determine a partitioned organizational culture indicator ratings and driver score for the advancement school culture driver for individuals who identify as female. The partitioned organizational culture indicator ratings may be organizational culture indicator ratings for a subset of the individuals at the organization that match a selected biographical characteristic.

At block 1120, the method 1100 may optionally include displaying to an organization leader a graphical breakdown of the level of agreement among the individuals at the organization. In an aspect, for example, the server 42 may execute the web application 50 and/or the display component 56 to control the user device 20 and/or web application client 22 to display to an organization leader a graphical breakdown of the level of agreement among the individuals at the organization. For example, the web application client 22 may display the user interface 800 including the charts 820.

At block 1122, the method 1100 may optionally include displaying leader an organization inventory, the organization culture scores, and a leader inventory score for each of the plurality of organizational culture drivers. In an aspect, for example, the server 42 may execute the web application 50 and/or the display component 56 to control the user device 20 and/or web application client 22 to display to the organization leader the initial organizational culture inventory, the organizational culture driver scores, and the leader inventory culture driver score for each of the plurality of organizational culture drivers.

At block 1124, the method 1100 may optionally include tracking activity of the individuals of the school and displaying a participation rate of the individuals. In an aspect, for example, the server 42 may execute the web application 50 and/or the display component 56 to control the user device 20 and/or web application client 22 to track activity of the individuals of the organization and display the participation rate of the individuals.

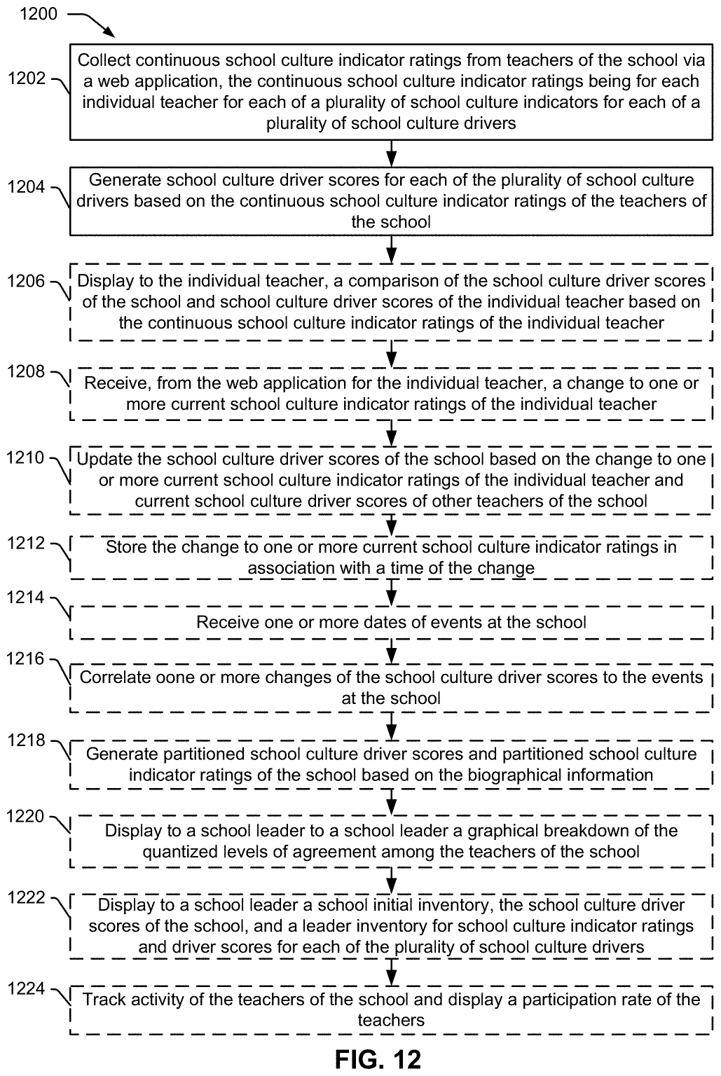

Referring to FIG. 12, in an operational aspect, a computer system 200 (FIG. 2) such as the user device 20 (FIG. 1) or a server 42 (FIG. 1) may perform one aspect of a method 1200 for measuring culture within an educational organization such as a school. While, for purposes of simplicity of explanation, the method 1200 is shown and described as a series of acts, it is to be understood and appreciated that the method (and further methods related thereto) is/are not limited by the order of acts, as some acts may, in accordance with one or more aspects, occur in different orders and/or concurrently with other acts from that shown and described herein. For example, it is to be appreciated that a method could alternatively be represented as a series of interrelated states or events, such as in a state diagram. Moreover, not all illustrated acts may be required to implement a method in accordance with one or more features described herein. Optional blocks are shown in dashed lines.

At block 1202, the method 1200 may include collecting continuous school culture indicator ratings from teachers of the school via a web application, the continuous school culture indicator ratings being for each individual teacher for each of a plurality of school culture indicators for each of a plurality of school culture drivers. In an aspect, for example, the server 42 may execute the web application 50 and/or the rating component 52 to collect continuous school culture indicator ratings from teachers of the school via a web application 50 and the web application client 22 executing on the user device 20. The continuous school culture indicator ratings may be implemented by, for example, the web application client 22 displaying the user interface 400. The user interface 400 may record a current school culture indicator rating for each individual teacher for each of a plurality of school culture indicators for each of a plurality of school culture drivers.

At block 1204, the method 1200 may include generating school culture driver scores for each of the plurality of school culture drivers based on the continuous school culture indicator ratings of the teachers of the school. In an aspect, for example, the server 42 may execute the web application 50 and/or the score component 54 to generate school culture driver scores for each of the plurality of school culture drivers based on the continuous school culture indicator ratings of the teachers of the school. For instance, the score component 54 may determine an individual school culture driver score for each of the plurality of school culture drivers for each teacher by averaging the ratings for each of the plurality of school culture indicator statements 432 for the driver. The score component 54 may determine the organization's school culture driver score for each school culture driver by averaging the individual scores for each school culture driver of teachers within the organization or school.

At block 1206, the method 1200 may optionally include displaying to the individual teacher, a comparison of school culture driver scores of the school and school culture driver scores of the individual teacher based on the continuous school culture indicator ratings of the individual teacher. In an aspect, for example, the server 42 may execute the web application 50 and/or the display component 56 to display to the individual teacher via the user device 20, a comparison of the school culture driver scores of the school and school culture driver scores of the individual teacher based on the continuous school culture indicator ratings of the individual teacher. For instance, the web application client 22 on the user device 20 may include the user interface 500 that displays bars 512 for the organization's school culture driver scores and line 514 for the individual culture scores.

At block 1208, the method 1200 may optionally include receiving, from the web application for the individual teacher, a change to one or more current school culture indicator ratings of the individual teacher. In an aspect, for example, the server 42 may execute the web application 50 and/or the rating component 52 to receive, from the web application client 22 for an individual teacher via the user device 20, a change to one or more current school culture indicator ratings of the individual teacher. For instance, the teacher (i.e., a user 30) may enter the changes on the user interface 400 and select the update button 440 to send the changes to the server 42.

At block 1210, the method 1200 may optionally include the school culture driver scores of the school based on the change to one or more current school culture indicator ratings of the individual teacher and current school culture driver scores of other teachers of the school. In an aspect, for example, the server 42 may execute the web application 50 and/or the score component 54 to the school culture driver scores of the school based on the change to one or more current school culture indicator ratings of the individual teacher and current school culture driver scores of other teachers of the school.

At block 1212, the method 1200 may optionally include storing the change to one or more current school culture indicator ratings in association with a time of the change. In an aspect, for example, the server 42 and/or storage server 43 may store (e.g., in a computer-readable medium) storing the change to one or more current school culture indicator ratings in association with a time of the change.

At block 1214, the method 1200 may optionally include receiving one or more dates of events at the school. In an aspect, for example, the server 42 may receive one or more dates of events at the school via the organizational leader system 60 and/or the user interface 900.

At block 1216, the method 1200 may optionally include correlating one or more changes of the school culture score to the events at the school. In an aspect, for example, the server 42 may execute the web application 50 and/or the score component 54 to correlate one or more changes of the school culture score to the events at the school.

At block 1218, the method 1200 may optionally include generating partitioned school culture driver scores and partitioned school culture indicator ratings of the school based on the biographical information. In an aspect, for example, the server 42 may execute the web application 50 and/or the score component 54 to generate partitioned school culture driver scores and partitioned school culture indicator ratings of the school based on the biographical information.

At block 1220, the method 1200 may optionally include displaying to a school leader to a school leader a graphical breakdown of the quantized levels of agreement among the teachers of the school. In an aspect, for example, the server 42 may execute the web application 50 and/or the display component 56 to control the user device 20 and/or web application client 22 to display to a school leader to a school leader a graphical breakdown of the quantized levels of agreement among the teachers of the school. For example, the web application client 22 may display the user interface 800 including the charts 820.

At block 1222, the method 1200 may optionally include displaying to a school leader a school initial inventory, the school culture driver scores of the school, and a leader inventory for school culture indicator ratings and driver scores for each of the plurality of school culture drivers. In an aspect, for example, the server 42 may execute the web application 50 and/or the display component 56 to control the user device 20 and/or web application client 22 to display to a school leader a school initial inventory, the school culture driver scores of the school, and a leader inventory for school culture indicator ratings and driver scores for each of the plurality of school culture drivers.

At block 1224, the method 1200 may optionally include tracking activity of the teachers of the school and displaying a participation rate of the teachers. In an aspect, for example, the server 42 may execute the web application 50 and/or the display component 56 to control the user device 20 and/or web application client 22 to track activity of the teachers of the school and display a participation rate of the teachers.

As used in this application, the terms “component,” “module,” “system” and the like are intended to include a computer-related entity, such as but not limited to hardware, firmware, a combination of hardware and software, software stored as executable instructions on a non-transitory computer readable medium, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal. A terminal can also be called a system, device, subscriber unit, subscriber station, mobile station, mobile, mobile device, remote station, remote terminal, access terminal, user terminal, terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with wireless terminal(s) and may also be referred to as an access point, a Node B, or some other terminology.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled with the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

In one or more aspects, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. While the foregoing disclosure discusses illustrative aspects and/or embodiments, it should be noted that various changes and modifications could be made herein without departing from the scope of the described aspects and/or embodiments as defined by the appended claims. Additionally, all or a portion of any aspect and/or embodiment may be utilized with all or a portion of any other aspect and/or embodiment, unless stated otherwise.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

What is claimed is:

1. A method of assessing a culture of a school, comprising:
collecting continuous school culture indicator ratings from teachers of the school via a web application, the continuous school culture indicator ratings being for each individual teacher for each of a plurality of school culture indicators for each of a plurality of school culture drivers; and
generating school culture driver scores for each of the plurality of school culture drivers based on the continuous school culture indicator ratings of the teachers of the school.

2. The method of claim 1, further comprising displaying to the individual teacher, a comparison of school culture driver scores of the school and school culture driver scores of the individual teacher based on the continuous school culture indicator ratings of the individual teacher.

3. The method of claim 1, wherein the web application includes a user interface that presents to the individual teacher a previous school culture indicator rating for each of the plurality of school culture indicators for one of the plurality of school culture drivers, wherein the user interface allows the individual teacher to change the previous school culture indicator ratings and to update the school culture driver scores of the school and the school culture driver scores of the individual teacher.

4. The method of claim 3, further comprising:
receiving, from the web application for the individual teacher, a change to one or more current school culture indicator ratings of the individual teacher; and
updating the school culture driver scores of the school based on the change to one or more current school culture indicator ratings of the individual teacher and current school culture driver scores of other teachers of the school.

5. The method of claim 4, further comprising storing the change to one or more current school culture indicator ratings in association with a time of the change.

6. The method of claim 5, further comprising:
receiving one or more dates of events at the school; and
correlating one or more changes of the school culture driver scores to the events at the school.

7. The method of claim 1, wherein the plurality of school culture drivers include: Direction, Profession Engagement, Instructional Autonomy, Collaboration, Empowerment, Feedback and Reflection, Resource Priorities, Support and Care, Sense of Belonging, and Teacher Advancement.

8. The method of claim 1, wherein the web application includes a user interface that collects biographical information of the individual teacher.

9. The method of claim 8, further comprising generating partitioned school culture driver scores and partitioned school culture indicator ratings of the school based on the biographical information.

10. The method of claim 9, wherein the partitioned school culture driver scores and partitioned school culture indicator ratings of the school are partitioned based on one or more of: teacher career length, teacher school service length, teacher-principal relationship length, number of schools for each teacher, or number of principals for each teacher.

11. The method of claim 1, wherein the school culture driver scores of the school are quantized levels of agreement among the teachers of the school regarding a level of each school culture driver at the school.

12. The method of claim 11, further comprising displaying to a school leader a graphical breakdown of the quantized levels of agreement among the teachers of the school.

13. The method of claim 1, further comprising displaying to a school leader a school initial inventory, the school culture driver scores of the school, and a leader inventory for school culture indicator ratings and driver scores for each of the plurality of school culture drivers.

14. The method of claim 1, further comprising tracking activity of the teachers of the school and displaying a participation rate of the teachers.

15. A method of assessing organizational culture, comprising:
collecting continuous organizational culture indicator ratings from individuals within an organization via a web application, the continuous organizational culture indicator ratings being for an individual for each of a plurality of organizational culture indicators for each of a plurality of organizational culture drivers, wherein the web application includes a user interface that presents to the individual a current organizational culture indicator rating for each of the plurality of organizational culture indicators for one of the plurality of organizational culture drivers;
generating organizational culture driver scores for each of the plurality of school culture drivers based on the continuous organizational culture indicator ratings of the individuals within the organization; and
displaying a comparison of the organizational culture driver scores and individual organizational culture driver scores based on the continuous organizational culture indicator ratings of the individual.

16. The method of claim 15, wherein the user interface allows the individual to change the current organizational culture indicator ratings and to update the organizational culture driver scores and the individual culture driver scores, the method further comprising:
receiving, from the web application for an individual, a change to one or more current organizational culture indicator ratings of the individual; and
updating the organizational culture driver scores based on the change to one or more current organizational culture indicator ratings of the individual and current organizational culture driver scores of other individuals of the organization.

17. The method of claim 16, further comprising storing the change of the current organizational culture indicator rating in association with a time of the change.

18. The method of claim 17, further comprising:
receiving one or more dates of events at the organization; and
correlating one or more changes of the organizational culture driver scores to an event at the organization.

19. The method of claim 15, wherein the web application includes a user interface that collects biographical information of the individual.

20. The method of claim 19, further comprising generating partitioned organizational culture scores and partitioned organizational culture indicator ratings for the organization based on the biographical information.

21. A user interface comprising:
a plurality of input screens displaying input mechanisms for collecting continuous school culture indicator ratings from a teacher of a school, each input screen recording a current school culture indicator rating for the teacher for each of a plurality of school culture indicators for one of a plurality of school culture drivers; and
a results interface displaying a comparison of school culture driver scores based on current school culture indicator ratings from a plurality of teachers of the school with an individual school culture driver score based on the continuous school culture indicator ratings of the teacher.

22. The user interface of claim 21, further comprising a biographical data input screen including input mechanisms for collecting biographical information of the teacher.

23. The user interface of claim 21, further comprising a leader result interface displaying school culture driver scores and indicator ratings partitioned based on biographical information of teachers of the school.

24. The user interface of claim 23, wherein the leader result interface displays changes in the school culture driver scores over time.
